(19) United States
(12) Patent Application Publication
(10) Pub. No.: US 2014/0117696 A1
(43) Pub. Date: May 1, 2014

(54) Apparatus for Multi-Positional Tailgate Extender

(71) Applicants: Thomas Laverne RICH, Alexandria, KY (US); Judith Ann Rich, Alexandria, KY (US)

(72) Inventors: Thomas Laverne RICH, Alexandria, KY (US); Judith Ann Rich, Alexandria, KY (US)

(21) Appl. No.: 14/064,410

(22) Filed: Oct. 28, 2013

Related U.S. Application Data
(60) Provisional application No. 61/720,576, filed on Oct. 31, 2012.

(51) Int. Cl. B60P 3/40

(52) U.S. Cl. CPC B60P 3/40
USPC 296/26.11

(57) ABSTRACT

An apparatus for multi-positional tailgate extender includes a first mounting bracket, a second mounting bracket, and a pivotable frame. The pivotable frame is hingedly connected with the first mounting bracket and the second mounting bracket, where the first mounting bracket and the second mounting bracket are connected to a cargo bed of a vehicle. The pivotable frame extends beyond the cargo bed about a rotation axis, where the pivotable frame positions in place with the second mounting bracket by a frame positioning mechanism and locks in place with the first mounting bracket by a frame locking mechanism so that object that are longer than the cargo bed can be safely transported.

The current application claims a priority to the U.S. Provisional Patent application Ser. No. 61/720,576 filed on Oct. 31, 2012.

### FIELD OF THE INVENTION

The present invention relates generally to an apparatus for a tailgate extender of a vehicle. More specifically, the present invention is an apparatus for a truck bed or cargo bed so that the respective vehicle is able to have an extended tailgate.

### BACKGROUND OF THE INVENTION

Pickup trucks and cargo vans are used people to transport many different types of loads. The transported loads can differ from one another as the transported loads vary with respect to the weight and size. Small size loads are easily transported by the average size pickup trucks and cargo vans, but people oftentimes have to choose full size pickup trucks or full size cargo vans to transport larger size loads even when the weight of those loads are irrelevant. Since the physical size of the transported load usually determines the required cargo bed size of the vehicle, people have to change vehicles in order to transport different size and length loads. For example, a larger cargo bed would allow for a larger load while a smaller cargo bed would only allow for a smaller size load.

It is therefore an object of the present invention to introduce a multi-positional tailgate extender that allows pickup trucks and cargo vans to effectively and safely transport many different size and length loads without having to change the vehicle. The present invention is efficiently stored within the cargo bed, resulting constant availability for the users. The user can easily extend the present invention with respect the cargo bed so that the present invention can be efficiently used with respect to larger size and length loads.

### BRIEF DESCRIPTION OF THE DRAWINGS

FIG. 1 is a perspective view of the present invention.

FIG. 2 is a top view of the present invention.

FIG. 3 is a perspective view of the pivotable frame of the present invention, showing the sections upon the detailed view are taken shown in FIG. 4 and FIG. 5.

FIG. 4 is a detailed view of the FIG. 3 taken along the section-A, showing the frame locking mechanism.

FIG. 4 is a detailed view of the FIG. 3 taken along the section-B, showing the frame positioning mechanism.

FIG. 6 is a perspective view of the first mounting bracket and the second mounting bracket of the present invention.

FIG. 7 is a top view of the first mounting bracket and the second mounting bracket of the present invention.

FIG. 8 is an inside view of the first mounting bracket of the present invention.

FIG. 9 is an inside view of the second mounting bracket of the present invention.

FIG. 10 is a perspective view of the present invention within the cargo bed, wherein the present invention is at the stowed position.

FIG. 11 is a top view of the present invention within the cargo bed, wherein the present invention is at the stowed position.

FIG. 12 is a perspective view of the present invention within the cargo bed, wherein the present invention is at the vertical position.

FIG. 13 is a side view of the present invention within the cargo bed, wherein the present invention is at the vertical position.

FIG. 14 is a perspective view of the present invention within the cargo bed, wherein the present invention is at the extended position.

FIG. 15 is a side view of the present invention within the cargo bed, wherein the present invention is at the extended position.

FIG. 16 is a perspective view of the present invention within the cargo bed, wherein the present invention is at the extended position with a loaded object.

### DETAIL DESCRIPTIONS OF THE INVENTION

All illustrations of the drawings are for the purpose of describing selected versions of the present invention and are not intended to limit the scope of the present invention.

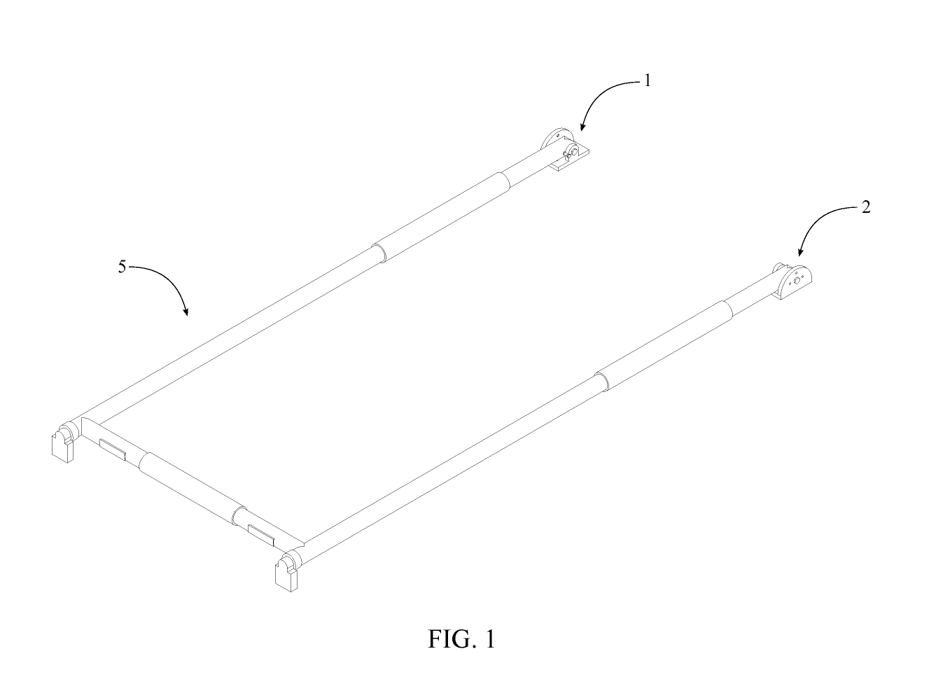

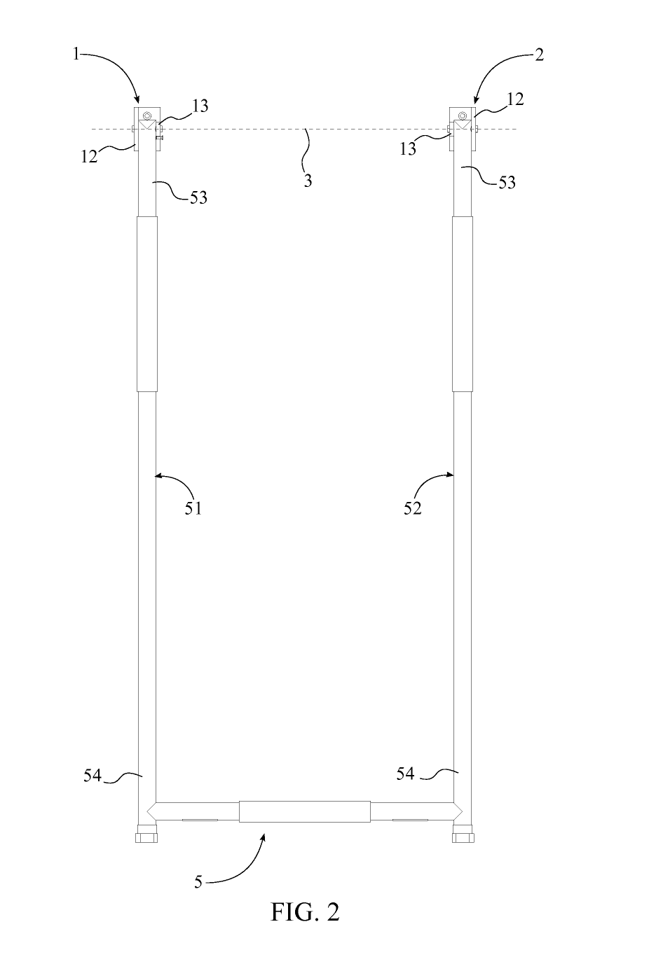

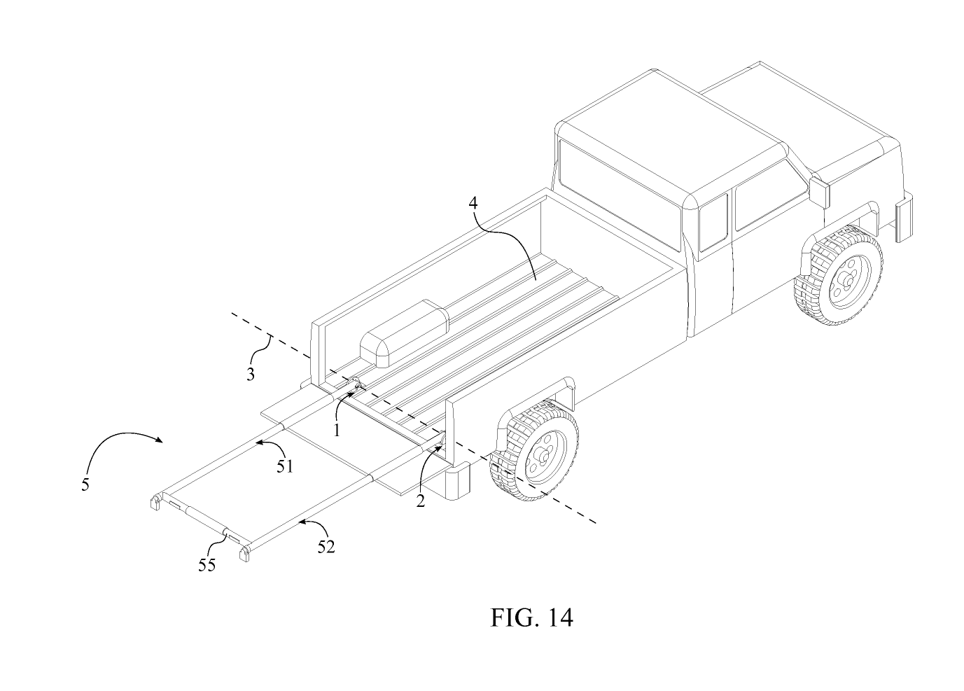

In reference to FIG. 1, FIG. 2, and FIG. 14, the present invention is an apparatus for multi-positional tailgate extender that is mounted on to a cargo bed 4 of a vehicle, where the cargo bed 4 of the vehicle can be a truck bed, van bed, or any other type of similar cargo bed. The present invention comprises a first mounting bracket 1, a second mounting bracket 2, and a pivotable frame 5. The pivotable frame 5 is hingedly connected with the first mounting bracket 1 and the second mounting bracket 2 about a rotation axis 3 as the first mounting bracket 1 and the second mounting bracket 2 are connected with the cargo bed 4. The rotation axis 3 extends parallel to the cargo bed 4 and traverses through the first mounting bracket 1 and the second mounting bracket 2. Since the present invention remains installed within the cargo bed 4, the present invention does not interfere with the usefulness of the cargo bed 4 when not in use and takes up a minimum amount of space within the cargo bed 4. When the present invention is used within the cargo bed 4, the present invention is extended beyond the cargo bed 4 for the securing of transported objects that would normally hang off from the end of cargo bed 4.

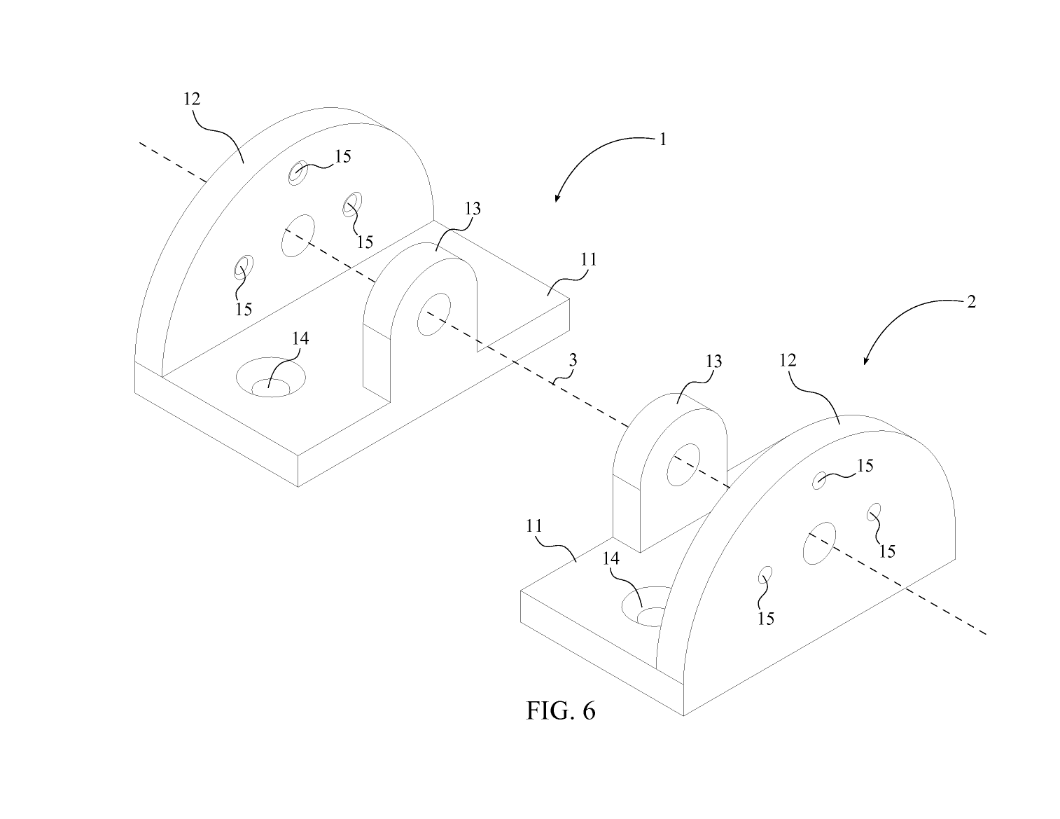

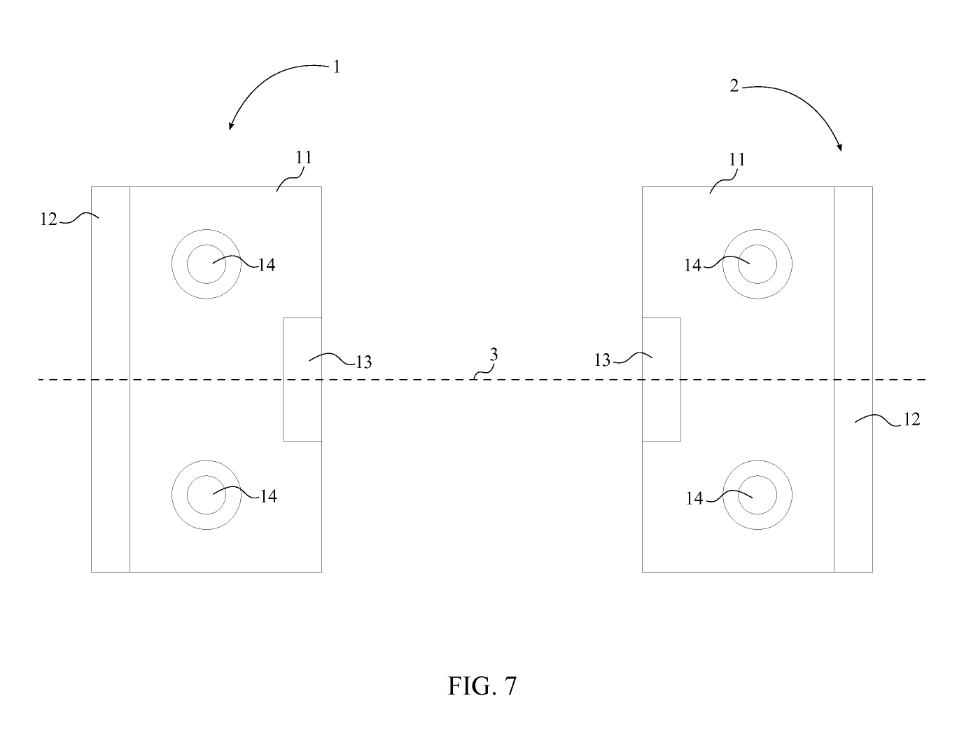

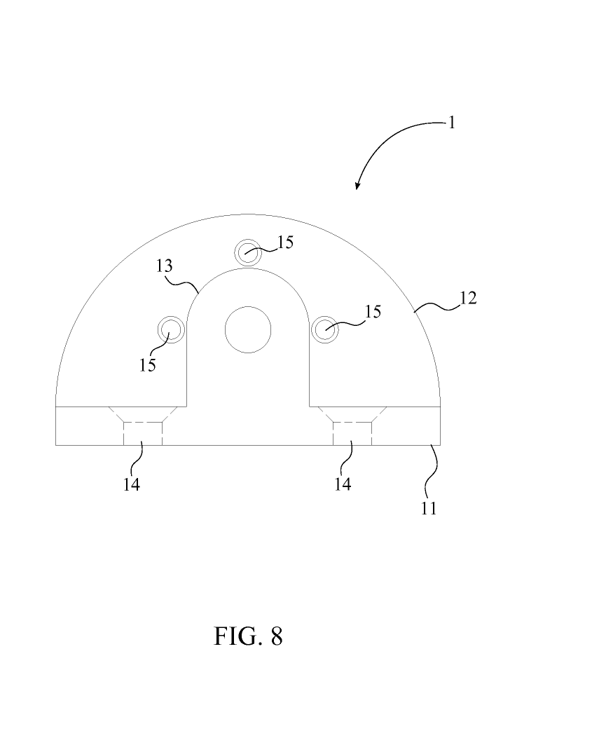

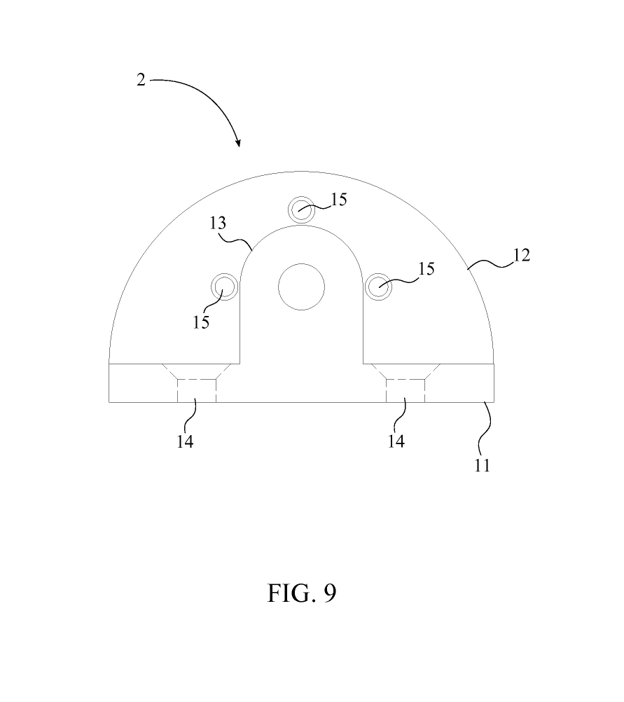

In reference to FIG. 6, the first mounting bracket 1 and the second mounting bracket 2 each comprise a base plate 11, an outer plate 12, an inner plate 13, a plurality of recessed mounting holes 14, and a plurality of locking cavities 15. The outer plate 12 is perpendicularly connected with the base plate 11, where the outer plate 12 is positioned flush with the base plate 11. The inner plate 13 is perpendicularly connected with the base plate 11 opposite from the outer plate 12, where the inner plate 13 is also positioned flush with the base plate 11. More specifically, the base plate 11, the outer plate 12, and the inner plate 13 complete a U-shaped member for the first mounting bracket 1 and the second mounting bracket 2. In reference to FIG. 7, FIG. 8, and FIG. 9, the plurality of recessed mounting holes 14 is traversed through the base plate 11 in such way that the plurality of recessed mounting holes 14 is linearly and centrally positioned in between the outer plate 12 and the inner plate 13. The plurality of recessed mounting holes 14 enables the first mounting bracket 1 and the second mounting bracket 2 to be connected with the cargo bed 4 through a plurality of fasteners. The general shape of the plurality of recessed mounting holes 14 creates a firm connection between the fasteners and the base plate 11 so that the present invention can be secured within the cargo bed 4. Additionally, a flat surface is also achieved in between the base plate 11 and the fasteners as the fastener heads sink into the plurality of recessed mounting holes 14. The plurality of locking cavities 15 is traversed through the outer plate 12, in such way that the plurality of locking cavities 15 radially positions around the rotation axis 3. The plurality of locking cavities 15 allows the hingedly connected pivotable frame 5 to be secured in different positions. In the preferred embodiment of the present invention, the plurality of locking cavities 15 is positioned at a stowed position, a vertical position, and an extended position, where each of the plurality of locking cavities 15 is ninety degrees apart from each other. More specifically, the vertical position is located in between the stowed position and the extended position, where the vertical position is 90 degrees from the stowed position, and the extended position is 90 degrees from the vertical position in such way that the extended position is 180 degrees from the stowed position.

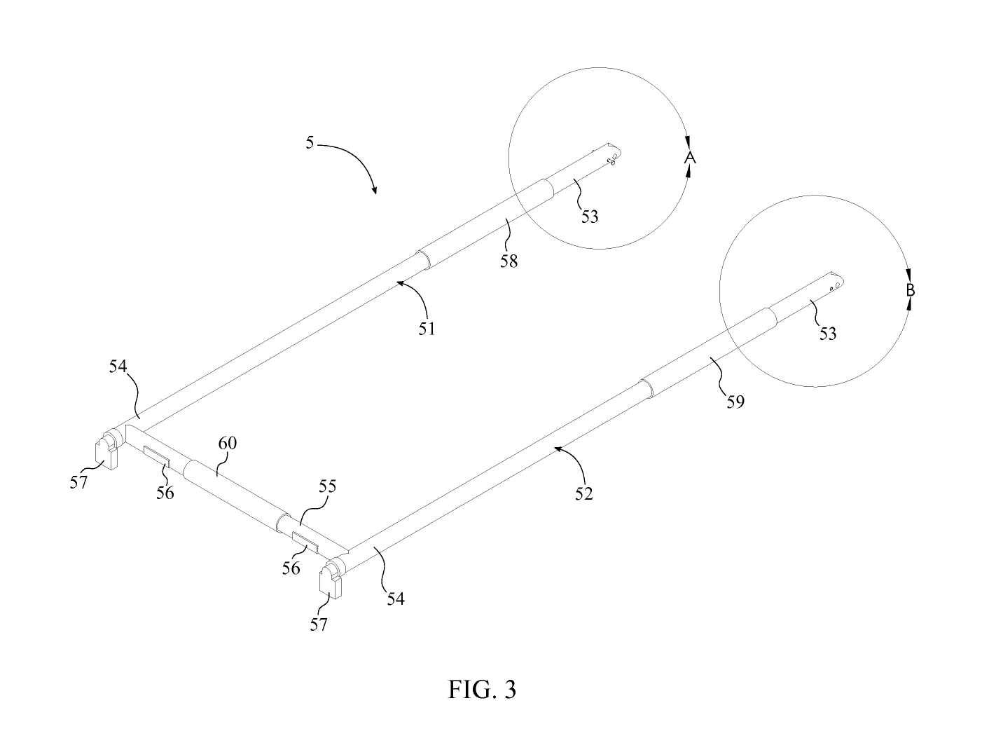

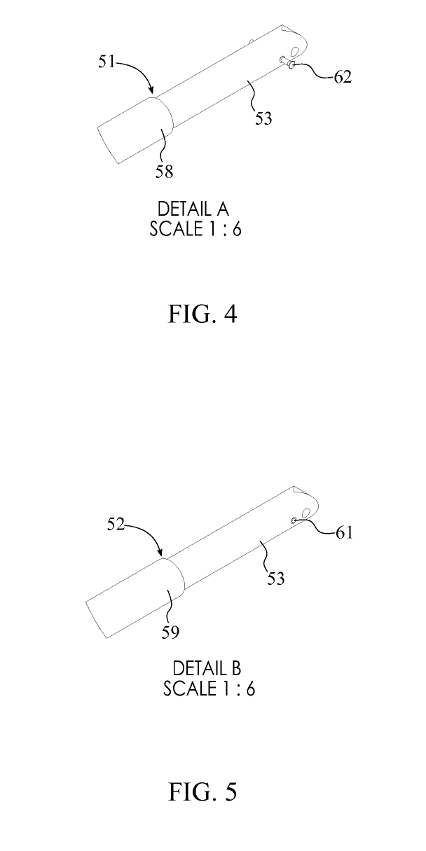

In reference to FIG. 3, FIG. 4, and FIG. 5, the pivotable frame 5 comprises a first arm 51, a second arm 52, a cross arm 55, a frame positioning mechanism 61, and a frame locking mechanism 62. The first arm 51 and the second arm 52 each comprise a proximal end 53 and a distal end 54, where the proximal end 53 and the distal end 54 are oppositely positioned from each other along the first arm 51 and the second arm 52. The first arm 51 is perpendicularly connected with the cross arm 55, and the second arm 52 is perpendicularly connected with the cross arm 55 opposite from the first arm 51. More specifically, the cross arm 55 is positioned in between the first arm 51 and the second arm 52 in such way that the cross arm 55 is adjacently positioned with the distal end 54 of the first arm 51 and the second arm 52. Additionally, the distal end 54 and the proximal end 53 of the first arm 51 are linearly aligned with the distal end 54 and the proximal end 53 of the second arm 52. The first arm 51, the second arm 52, and the cross arm 55 are constructed from high strength and light weight tubing, where the shape of the first arm 51, the second arm 52, and the cross arm 55 can include, but is not limited to, circular shaped tubing, square shaped tubing, or any other geometrical shaped tubing.

In reference to FIG. 3, the pivotable frame 5 further comprises a plurality of reflectors 56, a pair of brake lights 57, a first arm sleeve 58, a second arm sleeve 59, and a cross arm sleeve 60. The plurality of reflectors 56, which functions as a safety feature, is positioned along the cross arm 55 and oppositely positioned from the proximal end 53 of the first arm 51 and the second arm 52. Since the plurality of reflectors 56 is adjacently positioned toward the distal end 54 of the first arm 51 and the second arm 52, a plurality of reflectors 56 provides greater visibility to trailing vehicles so that the trailing vehicles can easily identify the distal ends 54 of the present invention. The pair of brake lights 57 is removably attached to the distal end 54 of the first arm 51 and the second arm 52, where the pair of brake lights 57 illuminates every time the driver applies brake to the vehicles. In order to supply the necessary electrical power for the pair of brake lights 57, the pair of brake lights 57 is electrically connected with existing trailer hitch power outlet of the vehicle. The first arm sleeve 58, the second arm sleeve 59, and the cross arm sleeve 60 provide protection to the pivotable frame 5 as the first arm 51, the second arm 52, and the cross arm 55 are respectively enclosed by the first arm sleeve 58, the second arm sleeve 59, and the cross arm sleeve 60. The positioning of the first arm sleeve 58, the second arm sleeve 59, and the cross arm sleeve 60 collectively protects the first arm 51, the second arm 52, and the cross arm 55 from the transported objects.

In reference to FIG. 2, as for the hingedly connection of the pivotable frame 5, the proximal end 53 of the first arm 51 is pivotally connected with the outer plate 12 and the inner plate 13 of the first mounting bracket 1 about the rotation axis 3, and the proximal end 53 of the second arm 52 is pivotally connected with the outer plate 12 and the inner plate 13 of the second mounting bracket 2 about the rotation axis 3.

In reference to FIG. 3 and FIG. 5, the frame positioning mechanism 61 is traversed into the proximal end 53 of the second arm 52, where the frame positioning mechanism 61 enables the pivotable frame 5 to individually position in place with each of the plurality of locking cavities 15 of the second mounting bracket 2. More specifically, the frame positioning mechanism 61 is selectively engaged with one of the plurality of locking cavities 15 of the second mounting bracket 2. In the preferred embodiment, a spring loaded ball plunger is used as the frame positioning mechanism 61, where the spring loaded ball plunger allows the pivotable frame 5 to position in place with respect to the stowed position, the vertical position, and the extended position. In reference to FIG. 3 and FIG. 4, the frame locking mechanism 62 is traversed into the proximal end 53 of the first arm 51, where the frame locking mechanism 62 enables the pivotable frame 5 to individually lock in place with each of the plurality of locking cavities 15 of the first mounting bracket 1. More specifically, the frame locking mechanism 62 is selectively engaged with one of the plurality of locking cavities 15 of the first mounting bracket 1. In the preferred embodiment, a spring loaded plunger pin is used as the frame locking mechanism 62, where the spring loaded plunger pin allows the pivotable frame 5 to lock in place with respect to the stowed position, the vertical position, and the extended position.

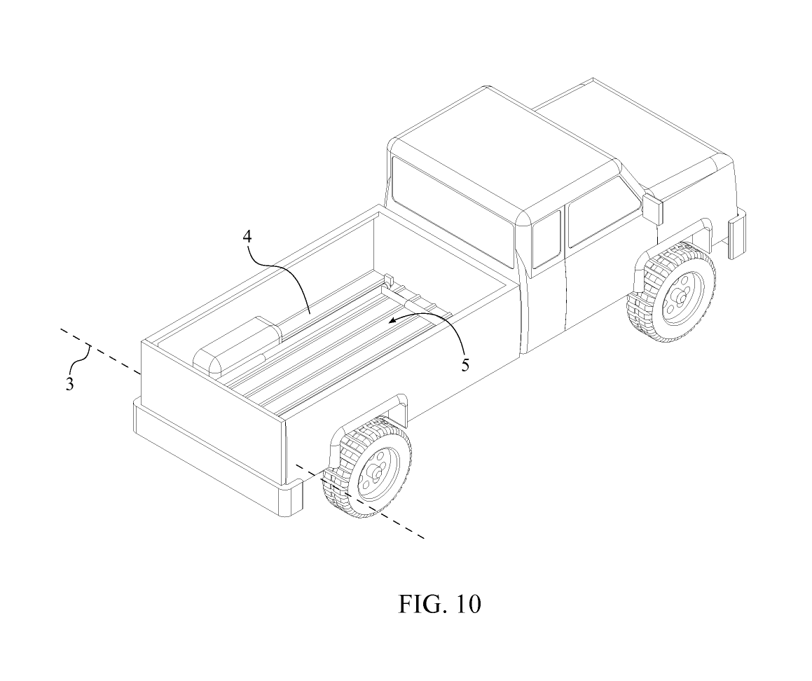

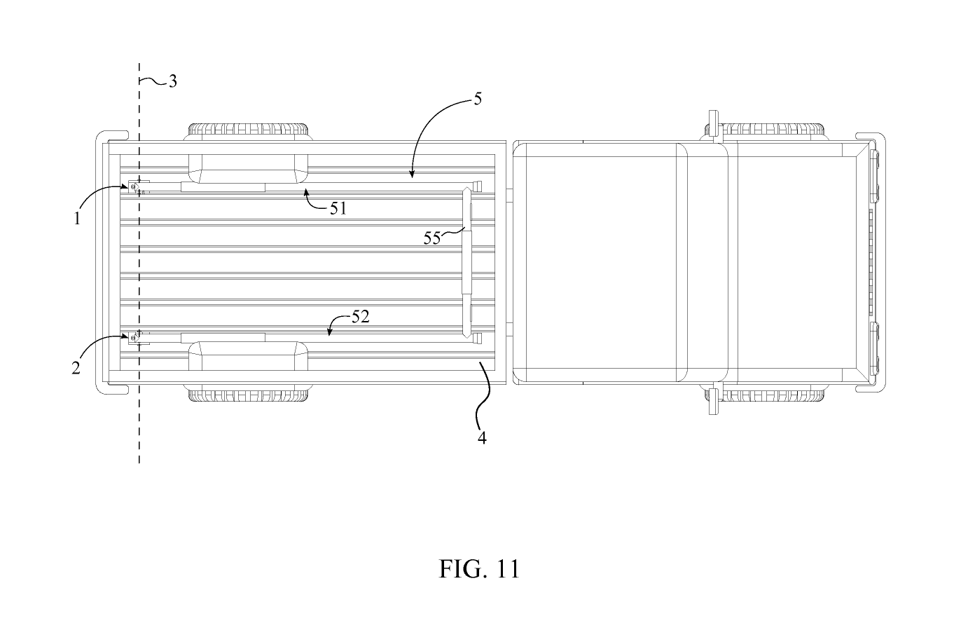

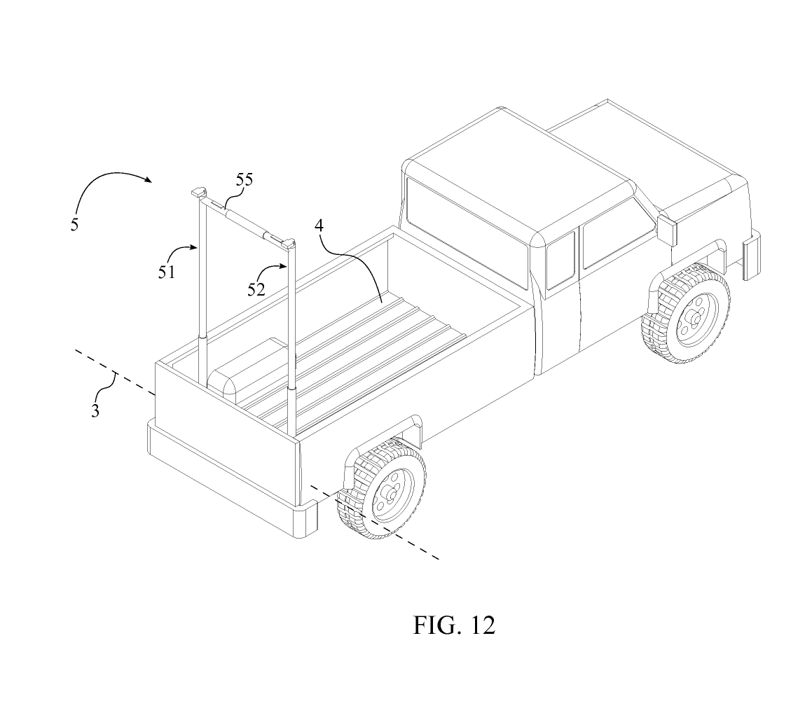

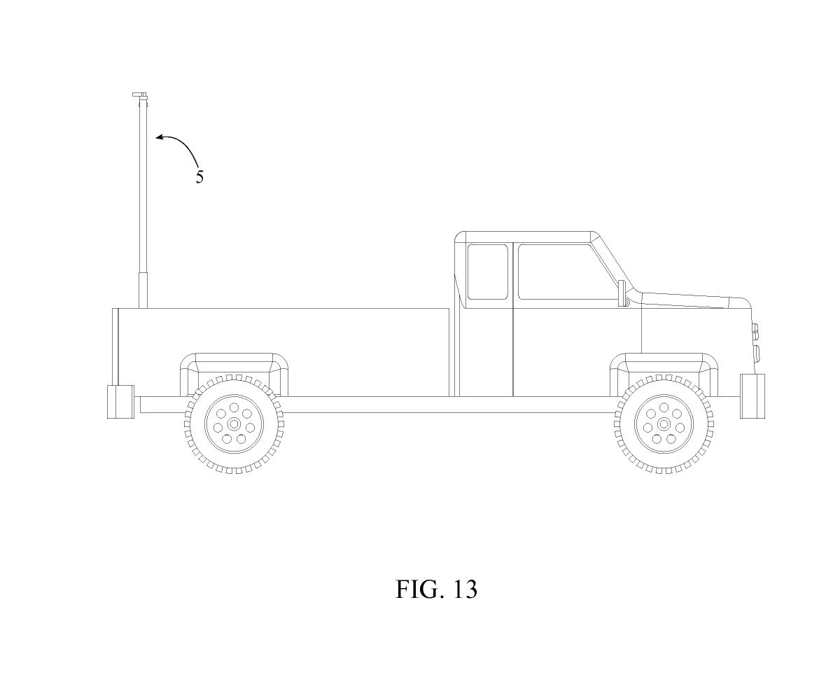

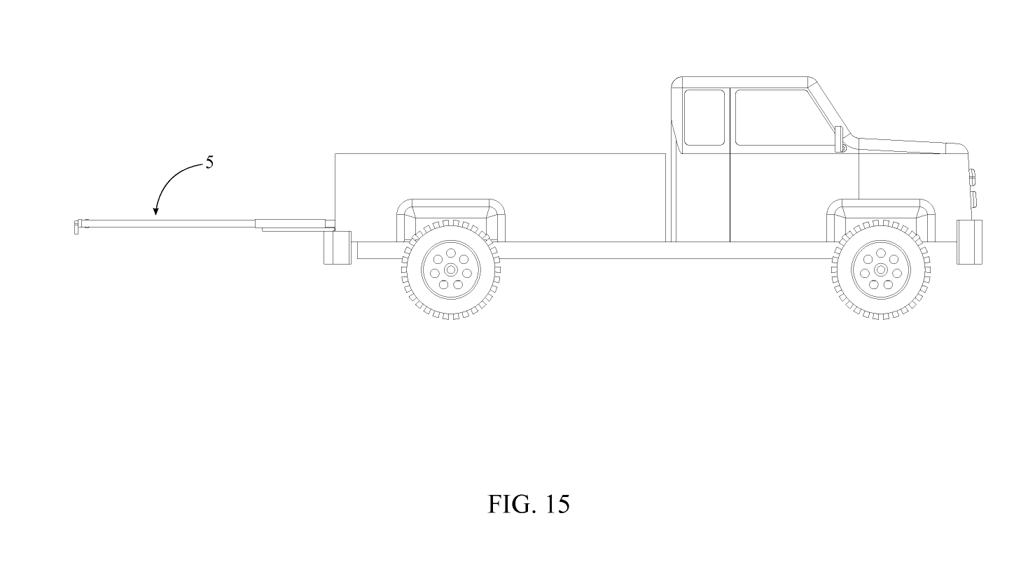

In reference to FIG. 10-FIG. 15, the users of the present can easily change the position of the pivotable frame 5 with the frame positioning mechanism 61 and the frame locking mechanism 62. More specifically, once the users disengaged the frame locking mechanism 62 from the first mounting bracket 1, the users can rotate the pivotable frame 5 around the rotation axis 3. As for the preferred embodiment of the present invention, when the frame positioning mechanism 61 reaches either the stowed position, the vertical position, or the extended position of the second mounting bracket 2, the frame positioning mechanism 61 positions the pivotable frame 5 within the first mounting bracket 1 and the second mounting bracket 2 with respect to the stowed position, the vertical position, or the extended position. Once the pivotable frame 5 is positioned according to the users' preference, which can be the stowed position, the vertical position, or the extended position, the users can engage the frame locking mechanism 62 with one of the plurality of locking cavities 15 of the first mounting bracket 1 so that the pivotable frame 5 can be locked within the first mounting bracket 1 and the second mounting bracket 2.

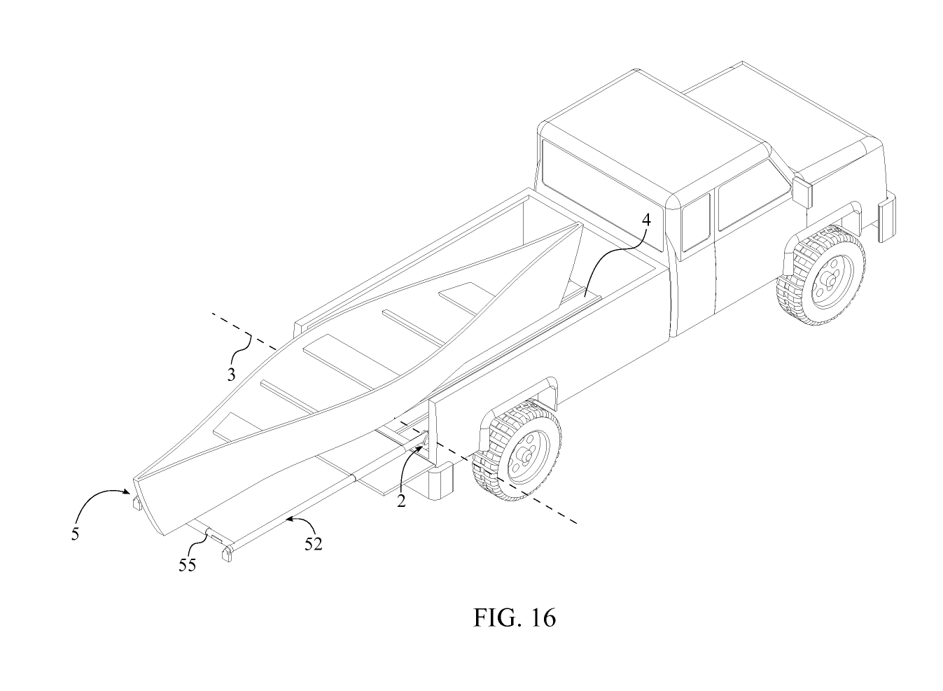

In reference to FIG. 16, the present invention enables the users to safely load, secure, and haul objects that are longer than the cargo bed 4 of a vehicle. Once the present invention is installed within the cargo bed 4, the present invention is left in place and there is no need to remove it when not in use. The pivotable frame 5 is simply placed out of the way in the stowed position with almost no effects on the usefulness or capacity of the cargo bed 4. When needed, the pivotable frame 5 is rotated to the vertical position or the extended position. In order for the present invention to be rotated in to the extended position, the users need to open the back door of the cargo bed 4 so that the pivotable frame 5 can be extended beyond the end of the cargo bed 4. The objects to be hauled are loaded into the cargo bed 4 and secured with ropes or straps to the cargo bed 4 and to the pivotable frame 5. Objects secured to the pivotable frame 5 must have at least ⅔ of their weight resting in either the cargo bed 4 or the cargo bed 4 and the back door.

Although the invention has been explained in relation to its preferred embodiment, it is to be understood that many other possible modifications and variations can be made without departing from the spirit and scope of the invention as hereinafter claimed.

What is claimed is:

1. An apparatus for multi-positional tailgate extender comprises:
a first mounting bracket;
a second mounting bracket;
a pivotable frame;
the first mounting bracket and the second mounting bracket each comprise a base plate, an outer plate, an inner plate, a plurality of recessed mounting holes, and a plurality of locking cavities;
the pivotable frame comprises a first arm, a second arm, a cross arm, a frame positioning mechanism, and a frame locking mechanism;
the first arm and the second arm each comprise a proximal end and a distal end; and
the pivotable frame being hingedly connected with the first mounting bracket and the second mounting bracket about a rotation axis.

2. The apparatus for multi-positional tailgate extender as claimed in claim 1 comprises:
the first mounting bracket and the second mounting bracket being connected to a cargo bed of a vehicle;
the rotation axis being parallel with the cargo bed; and
the rotation axis traversing through the first mounting bracket and the second mounting bracket.

3. The apparatus for multi-positional tailgate extender as claimed in claim 1 comprises:
the outer plate being perpendicularly connected with the base plate;
the inner plate being perpendicularly connected with the base plate opposite from the outer plate;
the plurality of recessed mounting holes traversing through the base plate;
the plurality of recessed mounting holes being linearly and centrally positioned in between the outer plate and the inner plate;
the plurality of locking cavities traversing through the outer plate; and
the plurality of locking cavities being radially positioned around the rotation axis.

4. The apparatus for multi-positional tailgate extender as claimed in claim 1 comprises:
the proximal end and the distal end being oppositely positioned from each other along the first arm and the second arm;
the first arm being perpendicularly connected with the cross arm;
the second arm being perpendicularly connected with the cross arm opposite from the first arm;
the cross arm being positioned in between the first arm and the second arm;
the cross arm being adjacently positioned with the distal end of the first arm and the second arm;
the distal end of the first arm and the second arm being linearly aligned with each other;
the proximal end of the first arm and the second arm being linearly aligned with each other;
the frame positioning mechanism traversing into the proximal end of the second arm; and
the frame locking mechanism traversing into the proximal end of the first arm.

5. The apparatus for multi-positional tailgate extender as claimed in claim 4 comprises:
a plurality of reflectors;
the plurality of reflectors being positioned along the cross arm; and
the plurality of reflectors being oppositely positioned from the proximal end of the first arm and the second arm.

6. The apparatus for multi-positional tailgate extender as claimed in claim 4 comprises:
a pair of brake lights; and
the pair of brake lights being removably attached to the distal end of the first arm and the second arm.

7. The apparatus for multi-positional tailgate extender as claimed in claim 4 comprises:
a first arm sleeve;
a second arm sleeve;
a cross arm sleeve;
the first arm being enclosed by the first arm sleeve;
the second arm being enclosed by the second arm sleeve; and
the cross arm being enclosed by the cross arm sleeve.

8. The apparatus for multi-positional tailgate extender as claimed in claim 1 comprises:
the proximal end of the first arm being pivotally connected with the outer plate and the inner plate of the first mounting bracket about the rotation axis; and
the proximal end of the second arm being pivotally connected with the outer plate and the inner plate of the second mounting bracket about the rotation axis.

9. The apparatus for multi-positional tailgate extender as claimed in claim 1 comprises:
the frame locking mechanism being selectively engaged with one of the plurality of locking cavities of the first mounting bracket; and
the frame positioning mechanism being selectively engaged with one of the plurality of locking cavities of the second mounting bracket.

10. An apparatus for multi-positional tailgate extender comprises:
a first mounting bracket;
a second mounting bracket;
a pivotable frame;
the first mounting bracket and the second mounting bracket each comprise a base plate, an outer plate, an inner plate, a plurality of recessed mounting holes, and a plurality of locking cavities;
the pivotable frame comprises a first arm, a second arm, a cross arm, a frame positioning mechanism, and a frame locking mechanism;
the first arm and the second arm each comprise a proximal end and a distal end;
the pivotable frame being hingedly connected with the first mounting bracket and the second mounting bracket about a rotation axis;
the first mounting bracket and the second mounting bracket being connected to a cargo bed of a vehicle;
the rotation axis being parallel with the cargo bed; and
the rotation axis traversing through the first mounting bracket and the second mounting bracket.

11. The apparatus for multi-positional tailgate extender as claimed in claim 10 comprises:
the outer plate being perpendicularly connected with the base plate;
the inner plate being perpendicularly connected with the base plate opposite from the outer plate;
the plurality of recessed mounting holes traversing through the base plate;
the plurality of recessed mounting holes being linearly and centrally positioned in between the outer plate and the inner plate;
the plurality of locking cavities traversing through the outer plate; and
the plurality of locking cavities being radially positioned around the rotation axis.

12. The apparatus for multi-positional tailgate extender as claimed in claim 10 comprises:
the proximal end and the distal end being oppositely positioned from each other along the first arm and the second arm;
the first arm being perpendicularly connected with the cross arm;
the second arm being perpendicularly connected with the cross arm opposite from the first arm;
the cross arm being positioned in between the first arm and the second arm;
the cross arm being adjacently positioned with the distal end of the first arm and the second arm;
the distal end of the first arm and the second arm being linearly aligned with each other;
the proximal end of the first arm and the second arm being linearly aligned with each other;
the frame positioning mechanism traversing into the proximal end of the second arm; and
the frame locking mechanism traversing into the proximal end of the first arm.

13. The apparatus for multi-positional tailgate extender as claimed in claim 12 comprises:
a plurality of reflectors;
the plurality of reflectors being positioned along the cross arm; and
the plurality of reflectors being oppositely positioned from the proximal end of the first arm and the second arm.

14. The apparatus for multi-positional tailgate extender as claimed in claim 12 comprises:
a pair of brake lights; and
the pair of brake lights being removably attached to the distal end of the first arm and the second arm.

15. The apparatus for multi-positional tailgate extender as claimed in claim 12 comprises:
a first arm sleeve;
a second arm sleeve;
a cross arm sleeve;
the first arm being enclosed by the first arm sleeve;
the second arm being enclosed by the second arm sleeve; and
the cross arm being enclosed by the cross arm sleeve.

16. The apparatus for multi-positional tailgate extender as claimed in claim 10 comprises:
the proximal end of the first arm being pivotally connected with the outer plate and the inner plate of the first mounting bracket about the rotation axis; and
the proximal end of the second arm being pivotally connected with the outer plate and the inner plate of the second mounting bracket about the rotation axis.

17. The apparatus for multi-positional tailgate extender as claimed in claim 10 comprises:
the frame locking mechanism being selectively engaged with one of the plurality of locking cavities of the first mounting bracket; and
the frame positioning mechanism being selectively engaged with one of the plurality of locking cavities of the second mounting bracket.
